(19) United States
(12) Patent Application Publication
(10) Pub. No.: US 2009/0040293 A1
(43) Pub. Date: Feb. 12, 2009

(54) Camera Array Apparatus and Method for Capturing Wide-Angle Network Video

(75) Inventors: Too-Jeow Foo, Singapore (SG); Steel Su, Sijhih City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEHAVIOR TECH COMPUTER CORP., Sijhih City (TW)

(21) Appl. No.: 12/188,511

(22) Filed: Aug. 8, 2008

(30) Foreign Application Priority Data
Aug. 8, 2007 (TW) 96129228

(51) Int. Cl. H04N 7/00

(52) U.S. Cl. 348/36; 348/E07.001

(57) ABSTRACT

A camera array apparatus and a method for capturing wide-angle network videos are provided. An objective of the present invention is to provide the webcams used for the common computer system or the like for broadcasting the real-time and wide-angle network video stream in a limited-bandwidth network. Furthermore, software is introduced to join the two or more images retrieved from the cameras and to form the wide-angle or panoramic video. The preferred embodiment of the camera array apparatus comprises a plurality of camera modules that are arranged as an array and are connected to the computer system. In particular, the mentioned images retrieved from the cameras are joined together from the wide-angle or panoramic video using a stitching process.

This application claims the benefit of priority based on Taiwan Patent Application No. 096129228, filed on Aug. 8, 2007, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a camera array apparatus and a method for capturing wide-angle network video. More particularly, the present invention relates to form a pantoscopic image by combining the pictures taken by two or more cameras through imaging processing.

2. Descriptions of the Related Art

Conventional digital cameras rely on a specific structure and imaging capability of a lens to take a picture by forming an image on an image sensor (e.g., a charge coupled device or a complementary metal-oxide-semiconductor sensor). The resulting image is then converted into a digital format (e.g., an RGB format) by the image sensor.

An ultra-wide-angle or a panoramic picture which overcomes viewing angle limitation of human eyes brings people a special experience owing to a wide viewing angle it exhibits. In order to take an ultra-wide-angle or a panoramic picture, a specially designed lens, such as a fish-eye lens or a rotatable camera is typically required, which increases the overall cost of the apparatus.

U.S. Pat. No. 5,752,113 disposes a conventional panoramic camera provides a panoramic effect by combining a plurality of pictures taken by a single camera. According to this patent, the panoramic effect is accomplished with a single camera mounted on a rotatable base. As shown in FIG. 1, a camera 120 is mounted on a supporting frame 100 in a tripod form. The camera 120 is adapted to rotate with the supporting frame 100 and take pictures of surrounding views in succession, during which the focal distance is adjusted as a function of a current viewing angle of the lens. Then, the superimposed areas between the images taken at different angles (e.g., portions 11, 12, and 13 labeled in this figure) are clipped by an image stitching technology, and the resulting images are combined to form a panoramic picture with a 360° viewing angle.

Another solution is to combine the pictures taken by a plurality of cameras to provide a pantoscopic effect. For example, a wide-angle imaging system and a method of capturing a real-time image thereof are disclosed in U.S. Pat. No. 7,084,904. This imaging system consists of a plurality of cameras, and pictures taken by each of the cameras are combined by using an image stitching technology to finally form a wide-angle picture. During this process, an image stitch table and a warp table unique to this patent are used for collation of the image distortions.

As shown in FIG. 2, a camera module 20 is configured to simulate a viewing angle range of users. The camera module 20 has a plurality of cameras 201, 202, 203, 204, 205, and 206 disposed around half of a circle, each of which has a respective viewing angle range. If the cameras have wide viewing angle ranges, fewer cameras may be required. Otherwise, if the cameras have narrow viewing angle ranges, more cameras will be required. Finally, pictures taken by individual cameras are combined by a back-end image stitching system.

### SUMMARY OF THE INVENTION

In the prior art, specially designed apparatuses and cameras are required to take a wide-angle, an ultra-wide-angle, or a panoramic picture. In contrast to this, the present invention discloses a camera array apparatus and a method for capturing wide-angle network video, which particularly employs webcams or other similar low-level cameras commonly used with a computer to capture pictures. Then, the pictures captured by two or more of the cameras are combined by software or firmware, so that the transmission of a wide-angle, an ultra-wide-angle, a panoramic network video, or a real-time image can be accomplished by using the simplest and cheapest apparatus.

In a preferred embodiment of the present invention, a camera array apparatus, which comprises a plurality of camera modules, is provided. However, in this embodiment, the camera modules are disposed as a whole in a receiving space and electrically connected to a computer system through only one connection interface unit. There is only one driving unit needed in the computer system to drive the camera array apparatus. Then, an image processing program stored in the computer system executes an image stitching process on the images captured by the camera modules, so that a wide-range or a panoramic image capable of real-time network transmission is formed.

Another embodiment of the present invention also employs a camera array apparatus to capture images. The camera array apparatus comprises a plurality of camera modules and is electrically connected to a computer system through a connection interface unit. The camera array apparatus further comprises an image processing unit for capturing a plurality of images taken by the camera modules and for executing an image stitching process on the images. These images are combined into a wide-angle or a panoramic image capable of real-time network transmission. In particular, the preferred embodiment of the image processing unit has a processor chip disposed in the array apparatus, which executes the imaging process with the hardware.

The present invention further utilizes the camera array apparatus described above for the capturing and transmission of a wide-angle or a panoramic image. Initially, such a camera array apparatus with a plurality of camera modules is prepared. After a hardware collation of the capturing angles and locations of the camera array apparatus, a plurality of images are taken, and finally, a software collation is executed according to the images.

In capturing the dynamic images, the images will be subjected to an image stitching process to combine the images taken by the camera modules into a wide-angle or a panoramic image for output from the computer system as a network video.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a panoramic imaging apparatus via a rotatable mechanism;

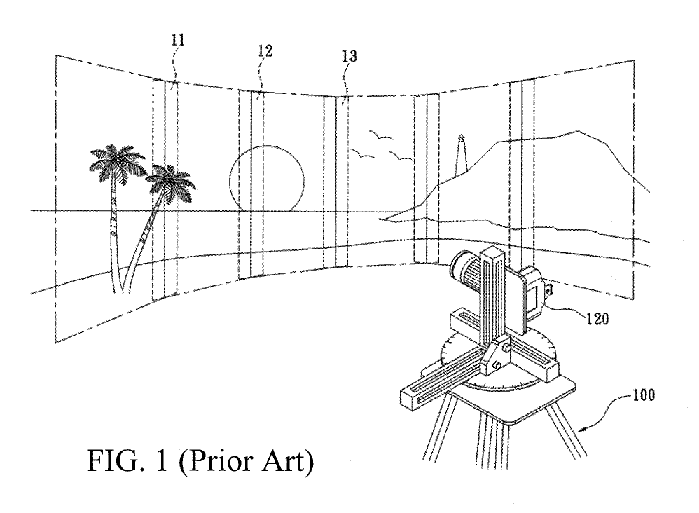

FIG. 2 illustrates a conventional wide-angle imaging system;

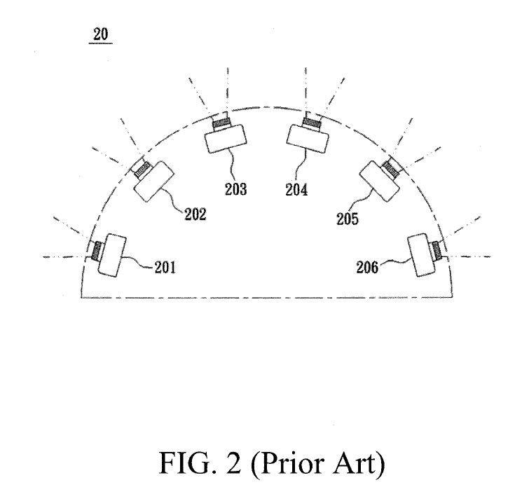

FIG. 3 is a schematic diagram illustrating the preferred embodiment of the present invention;

FIG. 4 is another schematic diagram illustrating the preferred embodiment of the present invention;

FIG. 5 is a schematic diagram illustrating the method for processing pictures taken by a plurality of camera modules through an image stitching technology;

FIG. 6 is a schematic diagram illustrating an embodiment of the camera array apparatus of the present invention;

FIG. 7 is another schematic diagram illustrating the embodiment of the camera array apparatus of the present invention; and

FIG. 8 is a flow chart of the method for capturing wide-angle network video of the present invention.

### DESCRIPTION OF THE PREFERRED EMBODIMENT

According to the present invention, two or more webcams are employed to capture a wide-angle or a panoramic image. Because webcams typically have low requirements on imaging quality, the resulting image is adapted more for real-time network transmission of video.

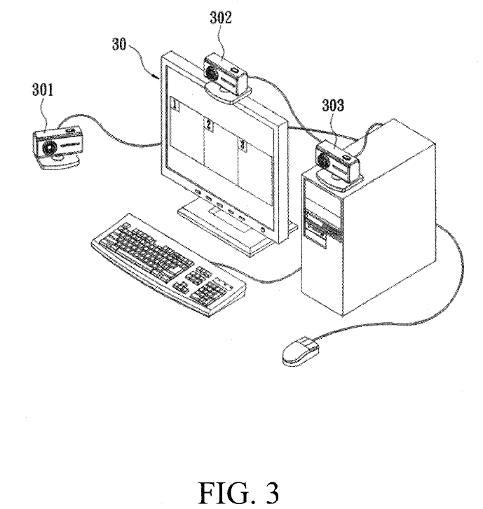

As shown in FIG. 3, an objective of the present invention is to employ a plurality of conventional webcams to capture a wide-angle or a panoramic image. In this embodiment, a first webcam 301, a second webcam 302, and a third webcam 303 operating independently from each other are included. The webeams are all electrically connected to a computer, preferably through a wireless or wired interface capable of connecting to most peripheral devices, such as a universal serial bus (USB) or a Firewire interface. The computer 30 has a driver or driving firmware for the webeams installed.

Because webeams made from different manufacturers have slight differences, these different characteristics need to be considered. For example, webcams from the same manufacturer tend to have similar imaging quality, while those from different manufacturers may have greatly varied imaging qualities. Different webcams generally have variation in terms of imaging characteristics such as white balance, color, or contrast. In a preferred embodiment, the driver is executed first to capture the images taken by individual webeams. Then, after adjustments to the white balance, color, contrast, synchronized time, and collation of the superimposed areas are made, these images are combined into a wide-angle image by an image stitching technology.

In FIG. 3, pictures captured by the individual cameras are particularly labeled on a computer screen. For example, a picture taken by the first webcam 301 is displayed on block 1 of the screen, a picture taken by the second webcam 302 is displayed on block 2, and a picture taken by the third webcam 303 is displayed on block 3. If there are superimposed areas between the adjacent images, they may be eliminated with either the software or the hardware. If eliminated by software, the image processing may be executed to obviate the image distortions. If eliminated by the hardware, the user may adjust the individual webcams to the appropriate directions or angles according to the pictures displayed on the screen when the webcams are initially installed to obtain an ideal wide-angle image.

The first webcam 301, the second webcam 302, and the third webcam 303 all have a distance respectively from the target or person. The superimposed areas may occur between the pictures when combined. One solution to this problem is to connect these images into a strip of images using conventional image stitching technology described above. In this embodiment, the image stitching process is as follows. Pictures taken by individual webcams are scanned to obtain the original image data including the border information. Then the pictures are divided into a plurality of areas, each of which is represented by a distance value to reflect the distance from the border. Finally, a threshold value is used to determine the superimposed areas between the images taken by the individual webcams, thus completing the stitching process.

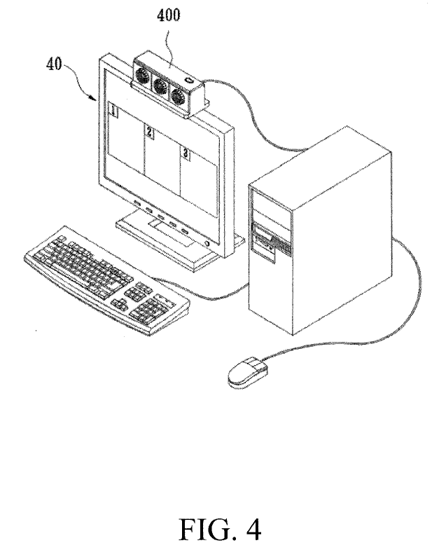

A camera array apparatus 400 in accordance with the preferred embodiment of the present invention is shown in FIG. 4. The camera array apparatus 400 is electrically connected to a computer 40, and particularly employs webcams commonly used with computers or other similar camera modules. As shown in FIG. 4, unlike the previous embodiment which employs webcams independent from each other, a plurality of webcams are assembled into the camera array apparatus 400. Pictures taken by the webcams are combined by the hardware or software in the computer 40. Then, various hardware and software collations and imaging parameter collations are executed as described above, and finally an image stitching process is performed to obtain a wide-angle or a panoramic image for real-time network video transmission.

In this embodiment, two or more camera modules are disposed in the camera array module 400. Rather than operating independently from each other, these camera modules are combined into a unitary unit, and are controlled by a single driver or some other driving means. When the apparatus is initially set up, the hardware of the apparatus is installed and image capturing angles of the camera modules are set. Particularly, the spacing between the individual camera modules is determined according to the focal distance and field of view of the camera modules. Then, the imaging parameters such as contrast, color, white balance, and time synchronization are set by an imaging process. During operation, pictures taken by individual camera modules are captured and subjected to a real-time image stitching process to obtain a wide-angle image for real-time network video transmission.

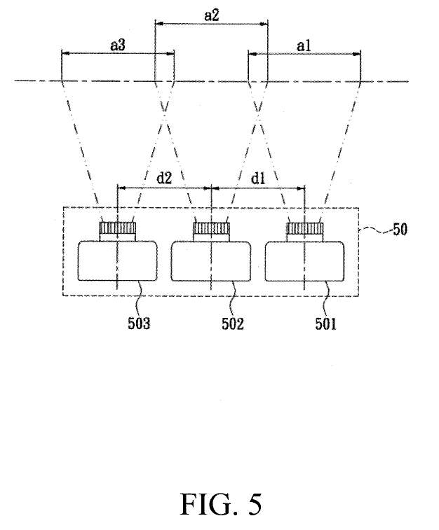

FIG. 5 is a schematic diagram illustrating the process of taking pictures with the plurality of camera modules by using image stitching technology. Here, the camera array apparatus 50 comprises a first camera module 501, a second camera module 502, and a third camera module 503. The number of camera modules may be varied according to the desired range of imaging.

In this embodiment, the hardware installation and the image capturing angles of the apparatus are decided according to practical installation scenarios. In particular, the spacing between individual camera modules is decided according to a focal distance and a field of view of the camera modules as described above, such as spacing dl between the first camera module 501 and the second camera module 502, as well as the spacing d2 between the second camera module 502 and the third camera module 503. Moreover, the captured view has a distance from the apparatus 50, while the camera modules have a capturing range labeled by a1, a2, and a3 respectively, with a superimposed area between the adjacent capturing ranges. According to the image stitching technology described above, the capturing ranges are first determined. The border areas are also determined before performing the image stitching process.

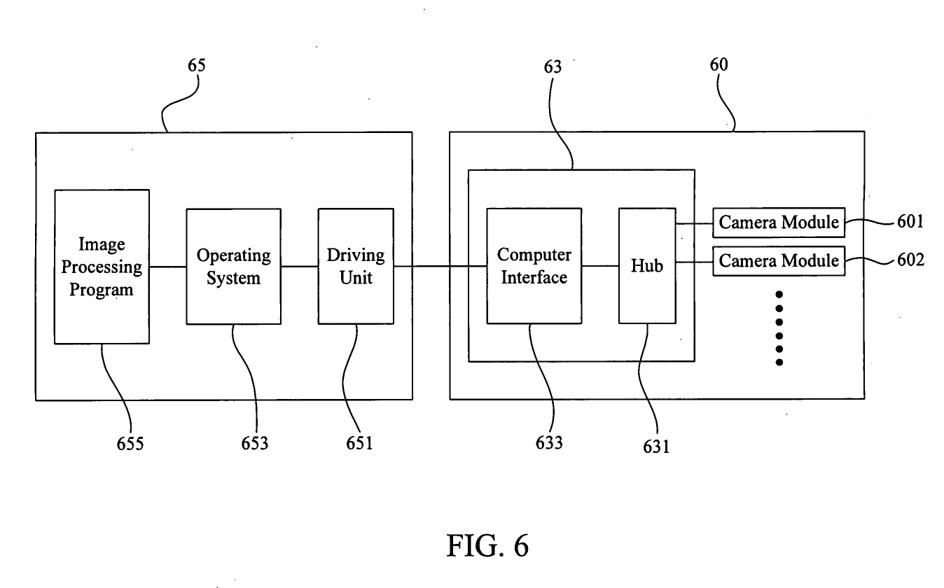

As shown in FIG. 6, an embodiment of the present invention provides a wide-angle or a panoramic image by use of two or more webcams. In this embodiment, there are two main components: a computer system 65 and a camera array apparatus 60.

The camera array apparatus 60 comprises a plurality of camera modules. FIG. 6 illustrates a first camera module 601 and a second camera module 602, each of which further comprises an independent lens and an image sensing unit (not shown, e.g., a CCD or a CMOS sensing unit). In this embodiment, the camera modules in the camera array module 60 are common webcams which generally adopt low-level image sensing units, and are arrayed in a receiving space of the camera array apparatus 60. The image capturing angles and imaging parameters of these camera modules are integrally set, as described above. During the hardware installation of the apparatus, the spacing of the camera modules is decided particularly according to the focal distance and field of view of the camera module.

The camera array apparatus 60 is also electrically connected to the computer system 65 through a connection interface unit 63, such as a USB or a Firewire interface. The connection interface unit 63 primarily comprises a hub 631 for connection to the camera modules and a computer interface 633 for connection to the computer system 65. The computer system 65 is configured to drive the camera array apparatus 60 with a driving unit 651 implemented by a software or firmware, and also to perform the control and capture functions. An operating system 653 is configured to retrieve the images captured by the camera array apparatus 60 through the driving unit 651, and then to process the retrieved image signals using the software image process. In this embodiment, an image processing program 655 residing in the computer system 65 is configured to obtain the images retrieved by the driving unit 651, adjust the imaging parameters and execute a real-time image stitching process, so that the images capable of real-time display on a display apparatus (not shown) and real-time network transmission are derived.

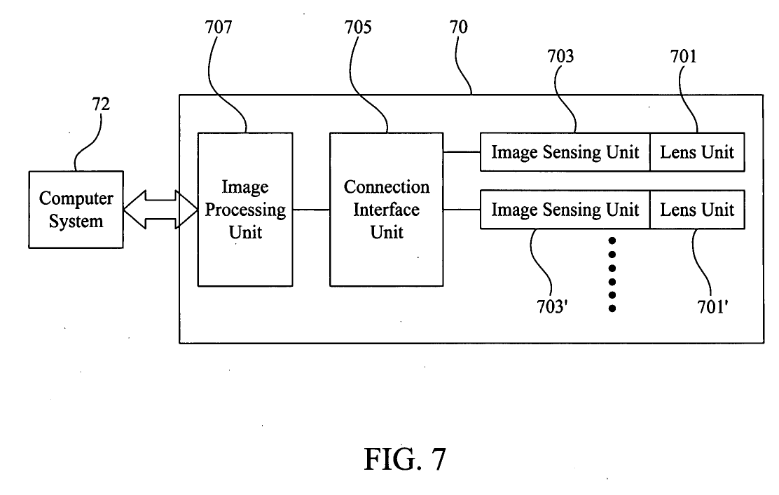

FIG. 7 illustrates another embodiment of the present invention 70, which comprises an image processing unit 705 with an image processing capability. The preferred embodiment of the image processing unit 705 consists of a processor chip (IC), rather than relying on the image processing function residing in the computer system.

In this embodiment, the camera array apparatus 70 comprises a plurality of camera modules. FIG. 7 illustrates a camera module consisting of a lens unit 701 and an image sensing unit 703, while the other camera module consists of a lens unit 701′ and an image sensing unit 703′. Further, more modules may be added as required. Each of the camera modules is electrically connected to the image processing unit 705 of the camera array apparatus 70. The image processing unit 705 is configured to receive the image signals from the individual camera modules, convert them into digital signals, and execute the imaging parameter collation and stitching process on the images. The imaging parameter collation, which may be executed prior to the practical operation, includes the collation of the white balance, color, contrast of the images, and even the synchronization of the capturing time between the individual camera modules to avoid errors that occur in the resulting picture due to time asynchronism. The image stitching process is executed in real time during the reception of these images.

The picture data processed by the image processing unit 705 is transmitted to a back-end computer system 72 through a connection interface unit 707, and is displayed to users on a display apparatus (not shown) electrically connected to the computer system 72. Because this invention mainly employs webcams commonly used for the network video capturing as an image capturing apparatus, the image data generated is more suitable for transmission through a limited-bandwidth network. A wide-angle or a panoramic image may be obtained by combining the images from a plurality of camera modules.

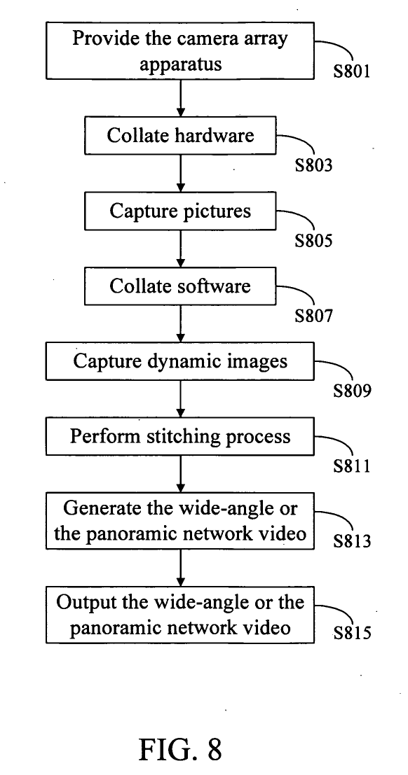

Corresponding to the aforesaid embodiments of the camera array apparatus, the preferred embodiment of the method for capturing wide-angle network videos is shown in FIG. 8.

The flow of this method primarily includes two portions, one of which is a hardware and software collation. Because the apparatus of this invention is comprised of different camera modules, the hardware and software collation performed before the operation of the apparatus may ensure a better image.

First, a camera array apparatus comprising a plurality of camera modules is provided, and in the preferred embodiment, the camera array apparatus is formed by a plurality of webcams in combination (step S801). Then, a hardware collation is executed, including the collation of capturing angles and locations of lens in the individual camera modules, and the spacing between the camera modules are decided according to the focal distance and field of view of the modules. In particular, the software or firmware driving means residing in the computer system should operate properly (step S803). Next, dynamic images are captured by the individual camera modules (step S805). Subsequently, a software or firmware collation is executed according to the images captured, in which the differences between the images captured by different camera modules are collated. These differences may include white balance, color and contrast. An optimal wide-angle picture will be obtained by combining these images (step S807).

Through the software and hardware collation executed in steps S801 to S807 described above, the camera modules are ensured to operate properly.

Subsequently, the computer system controls the camera array apparatus through the driving unit to capture dynamic images when network videos are captured (step S809). The images are captured picture by picture and are stitched in real-time. The stitching process is performed using a pure software program (e.g., an image processing program) in combination with a central processing unit or a single image processing chip to connect the images into a strip of images. In the preferred embodiment, pictures taken by the camera modules are scanned by various image processing means described above to obtain border information. The superimposed areas on the borders between the adjacent pictures are determined according to the border information. With such information, an image stitching process is executed (step S811), and then the pictures are combined into a wide-angle or a panoramic network video (step S813) before being outputted from the computer system (step S815).

In the primary embodiment of this invention, webcams are used as the camera modules that capture the images used for a wide-angle or a panoramic image. The resulting image quality is more suitable for network video applications and can facilitate the real-time network transmission of a wide-angle or a panoramic image.

In summary, this invention relates to a camera array apparatus and a method for capturing wide-angle network videos. In particular, to obtain a wide-angle image, pictures taken by two or more cameras are combined. The image processing including an image stitching operation and an imaging parameter collation is performed using software or firmware. The image data thus generated is suitable for real-time network video transmission and may further provide a wide-angle image combining the images.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A camera array apparatus, comprising:
a plurality of camera modules arrayed in a receiving space; and
a connection interface unit, through which the camera array apparatus is electrically connected with a computer system, the computer system being adapted to drive the camera array apparatus by a drive unit and capture a plurality of images taken by the camera modules;
whereby the computer system having an image processing program which is adapted to execute a stitching operation in accordance with the images to form one of a pantoscopic image and a panoramic image being capable of real-time network transmission.

2. The camera array apparatus as claimed in claim 1, wherein each of the camera modules of the camera array apparatus is a network video camera.

3. The camera array apparatus as claimed in claim 1, wherein the connection interface unit further comprises a hub and a computer interface.

4. The camera array apparatus as claimed in claim 1, wherein the plurality of camera modules connect to a universal serial bus (USB) hub and electrically connect to the computer system through a computer interface.

5. The camera array apparatus as claimed in claim 1, wherein each of the camera modules has a focal distance which is adapted to determine the distance spaced apart from one of the camera modules to another, in association with a field of view.

6. The camera array apparatus as claimed in claim 1, wherein the camera array apparatus executes a collation of each of the images through the image processing program, the collation of which comprises white balance, color, contrast, and synchronization of a taking time.

7. A camera array apparatus, comprising:
a plurality of camera modules arrayed in a receiving space;
a connection interface unit, through which the camera array apparatus is electrically connected with a computer system; and
an image processing unit for capturing a plurality of images taken by the camera modules and for executing a stitching operation in accordance with the images to form one of a pantoscopic image and a panoramic image being capable of real-time network transmission.

8. The camera array apparatus as claimed in claim 7, wherein the image processing unit is a processing chip, disposed in the camera array apparatus, for executing an image process by hardware.

9. The camera array apparatus as claimed in claim 7, wherein each of the camera modules of the camera array apparatus is a network video camera.

10. The camera array apparatus as claimed in claim 7, wherein the connection interface unit is a USB hub.

11. The camera array apparatus as claimed in claim 7, wherein each of the camera modules has a focal distance which is adapted to determine the distance spaced apart from one of the camera modules to another, in association with a field of view.

12. The camera array apparatus as claimed in claim 7, wherein the camera array apparatus executes a collation of each of the images through the image processing unit, the collation of which comprises white balance, color, contrast, and synchronization of a taking time.

13. A method for capturing wide-angle network video, comprising the following steps:
providing a camera array apparatus, wherein the camera array apparatus comprises a plurality of camera modules arrayed in a receiving space;
capturing a plurality of dynamic images;
executing a stitching process in accordance with the dynamic images;
combining the dynamic images taken by the camera modules to form one of a pantoscopic image and a panoramic image; and
outputting one of the pantoscopic image and the panoramic image by a computer system;
wherein each of the camera modules of the camera array apparatus is a network video camera, and the camera array apparatus combines the dynamic images to form one of the pantoscopic image and the panoramic image being capable of real-time network transmission.

14. The capturing method as claimed in claim 13, wherein the stitching process is adapted to scan a picture taken by each of the camera modules through an image process to acquire boundary information of each of the picture and determine a superimposed area of each of the picture.

15. The capturing method as claimed in claim 14, wherein the image process is executed through an operation of a central processor of the computer system and an image processing program.

16. The capturing method as claimed in claim 14, wherein the image process is executed by an image processing chip.

17. The capturing method as claimed in claim 13, wherein the step of capturing a plurality of dynamic images further comprises the steps of:
capturing a picture taken by each of the camera modules; and
executing a real-time stitching process in accordance with each of the picture.

18. The capturing method as claimed in claim 13, wherein the step of providing a camera array apparatus further comprises the steps of:
providing a camera array apparatus comprising a plurality of camera modules;
executing a hardware collation of the camera array apparatus;
taking an image through each of the camera modules of the camera array apparatus; and
executing a software collation according to the images taken by the camera modules;

19. The capturing method as claimed in claim 18, wherein the hardware collation of the camera array apparatus is adapted to adjust a taking angle and a taking position of a lens of each of the camera modules to confirm that each of the camera modules is driven normally.

20. The capturing method as claimed in claim 19, wherein the hardware collation is adapted to determine a distance spaced apart from one of the camera modules to another, in association with a field of view.

21. The capturing method as claimed in claim 18, wherein the software collation of the camera array apparatus is adapted to execute in accordance with image variation between pictures generated by the camera modules.

22. The capturing method as claimed in claim 21, wherein a parameter of the software collation comprises white balance, color, and contrast.
